(19) United States
(12) Patent Application Publication
(10) Pub. No.: US 2017/0308583 A1
(43) Pub. Date: Oct. 26, 2017

(54) Suggested Queries Based on Interaction History on Online Social Networks

(71) Applicant: Facebook, Inc., Menlo Park, CA (US)

(72) Inventors: Aliasgar Mumtaz Husain, Milpitas, CA (US); Sung-eok Jeon, Bellevue, WA (US)

(21) Appl. No.: 15/133,620

(22) Filed: Apr. 20, 2016

(51) Int. Cl. G06F 17/30; G06F 17/27

(52) U.S. Cl. CPC G06F 17/30528; G06F 17/30958; G06F 17/2705; G06F 17/2775; G06F 17/30867

(57) ABSTRACT

In one embodiment, a method includes receiving, from a user of an online social network, a text query comprising one or more n-grams inputted by the user. The method also includes identifying a first set of candidate keyword phrases matching the one or more n-grams of the text query, where each candidate keyword phrase in the first set includes one or more n-grams extracted from content associated with a third-party content object interacted with by the user. The method also includes calculating a rank for each of the identified candidate keyword phrases based at least in part on a social-interaction history of the user and sending, to the user in response to the user inputting the one or more n-grams of the text query, one or more suggested queries, where at least one of the suggested queries includes one of the identified candidate keyword phrases.

### TECHNICAL FIELD

This disclosure generally relates to social graphs and performing searches for objects within a social-networking environment.

### BACKGROUND

A social-networking system, which may include a social-networking website, may enable its users (such as persons or organizations) to interact with it and with each other through it. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may send over one or more networks content or messages related to its services to a mobile or other computing device of a user. A user may also install software applications on a mobile or other computing device of the user for accessing a user profile of the user and other data within the social-networking system. The social-networking system may generate a personalized set of content objects to display to a user, such as a newsfeed of aggregated stories of other users connected to the user.

Social-graph analysis views social relationships in terms of network theory consisting of nodes and edges. Nodes represent the individual actors within the networks, and edges represent the relationships between the actors. The resulting graph-based structures are often very complex. There can be many types of nodes and many types of edges for connecting nodes. In its simplest form, a social graph is a map of all of the relevant edges between all the nodes being studied.

### SUMMARY OF PARTICULAR EMBODIMENTS

In particular embodiments, the social-networking system may provide a user of the online social network customized keyword query suggestions based on the user's interactions with third-party content objects. A user interface of the social-networking system may comprise fields for displaying one or more query suggestions associated with each search instance. Instead of inputting a complete search query into a query field, a user may conduct a search against the online social network by, for example, clicking on one of the query suggestions. The efficiency of searching may be improved if the displayed query suggestions are customized to match the querying user's interests, such that the querying user's probability of using at least one of the query suggestions is increased. Query suggestions may be generated based on keyword phrases extracted from a variety of sources such as, for example, a name of a user or an entity on the online social network, a search history associated with the querying user or a social connection of the querying user, a list of trending-topic keyword phrases on the online social network, a language database, another suitable source, or any combination thereof. In particular embodiments, the social-networking system may customize its query suggestions to fit the interests of the querying user by generating suggested keyword queries based on a browsing history or activity log of the querying user. Specifically, keyword query suggestions may comprise keyword phrases extracted from content associated with third-party content objects that the querying user has recently interacted with. For example, a querying user may have recently accessed, shared, commented on, or otherwise interacted with an article about water on Mars that is published on a website specialized in astronomy news and made available on the online social network via one or more links. Based on an activity log of the querying user, the social-networking system may provide the querying user one or more keyword query suggestions each incorporating one or more keyword phrases associated with the article (e.g., “water on mars,” “wet habitats on mars”).

In particular embodiments, the social-networking system may receive a text query from a user. The social-networking system may have generated a plurality of candidate keyword phrases by extracting n-grams from content associated with third-party content objects that may be accessed by users of the online social network and stored the keyword phrases in association with the third-party content objects. In response to the querying user's input and based on a browsing history or activity log of the querying user, the social-networking system may identify one or more third-party content objects recently interacted with by the querying user and access candidate keyword phrases stored in association with the identified content objects. The social-networking system may then generate keyword query suggestions matching the inputted text query and comprising one or more of the accessed keyword phrases. The keyword query suggestions may then be provided to the querying user. Particular embodiments of the social-networking system may further generate and provide one or more suggested keyword queries incorporating keyword phrases that have been generated and stored in association with native content objects of the online social network (in addition to suggested keyword queries based on third-party content objects). Keyword query suggestions provided according to particular embodiments disclosed herein may aid a user in further exploring topics that the user has encountered or read about on the online social network or a third-party system.

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2 illustrates an example social graph.

FIG. 3 illustrates an example partitioning for storing objects of social-networking system 160.

FIG. 4 illustrates an example newsfeed interface for displaying content associated with third-party content objects.

FIG. 5 illustrates an example newsfeed interface for displaying suggested queries.

FIG. 6 illustrates an example method 600 for providing customized keyword query suggestions related to third-party content objects.

FIG. 7 illustrates an example computer system.

### DESCRIPTION OF EXAMPLE EMBODIMENTS

### System Overview

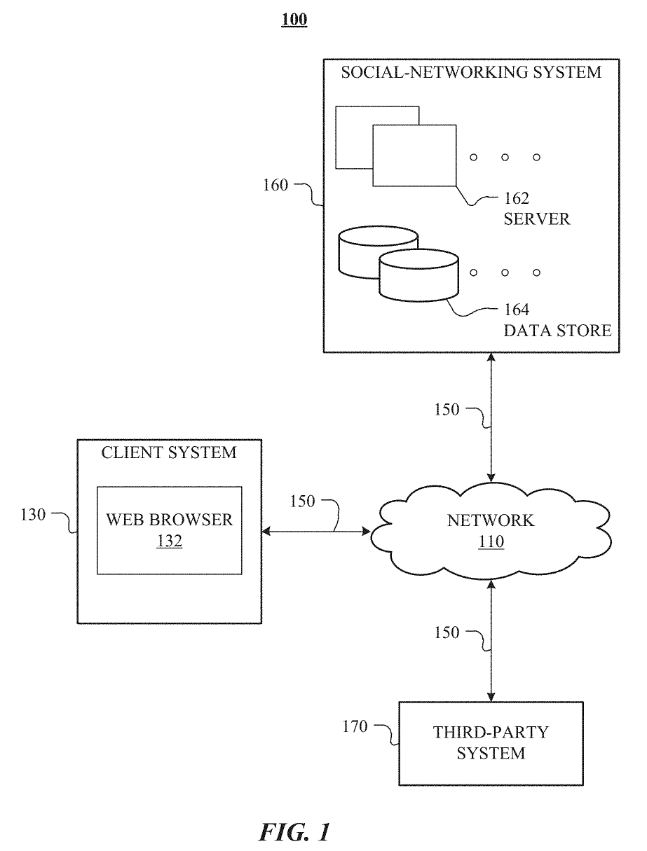

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of a client system 130, a social-networking system 160, a third-party system 170, and a network 110, this disclosure contemplates any suitable arrangement of a client system 130, a social-networking system 160, a third-party system 170, and a network 110. As an example and not by way of limitation, two or more of a client system 130, a social-networking system 160, and a third-party system 170 may be connected to each other directly, bypassing a network 110. As another example, two or more of a client system 130, a social-networking system 160, and a third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client systems 130, social-networking systems 160, third-party systems 170, and networks 110.

This disclosure contemplates any suitable network 110. As an example and not by way of limitation, one or more portions of a network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. A network 110 may include one or more networks 110.

Links 150 may connect a client system 130, a social-networking system 160, and a third-party system 170 to a communication network 110 or to each other. This disclosure contemplates any suitable links 150. In particular embodiments, one or more links 150 include one or more wireline (such as for example Digital Subscriber Line (DSL) or Data Over Cable Service Interface Specification (DOC SIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout a network environment 100. One or more first links 150 may differ in one or more respects from one or more second links 150.

In particular embodiments, a client system 130 may be an electronic device including hardware, software, or embedded logic components or a combination of two or more such components and capable of carrying out the appropriate functionalities implemented or supported by a client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at a client system 130 to access a network 110. A client system 130 may enable its user to communicate with other users at other client systems 130.

In particular embodiments, a client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at a client system 130 may enter a Uniform Resource Locator (URL) or other address directing a web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to a client system 130 one or more Hyper Text Markup Language (HTML) files responsive to the HTTP request. The client system 130 may render a web interface (e.g. a webpage) based on the HTML files from the server for presentation to the user. This disclosure contemplates any suitable source files. As an example and not by way of limitation, a web interface may be rendered from HTML files, Extensible Hyper Text Markup Language (XHTML) files, or Extensible Markup Language (XML) files, according to particular needs. Such interfaces may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web interface encompasses one or more corresponding source files (which a browser may use to render the web interface) and vice versa, where appropriate.

In particular embodiments, the social-networking system 160 may be a network-addressable computing system that can host an online social network. The social-networking system 160 may generate, store, receive, and send social-networking data, such as, for example, user-profile data, concept-profile data, social-graph information, or other suitable data related to the online social network. The social-networking system 160 may be accessed by the other components of network environment 100 either directly or via a network 110. As an example and not by way of limitation, a client system 130 may access the social-networking system 160 using a web browser 132, or a native application associated with the social-networking system 160 (e.g., a mobile social-networking application, a messaging application, another suitable application, or any combination thereof) either directly or via a network 110. In particular embodiments, the social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, the social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, the social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. The social-networking system 160 may provide users of the online social network the ability to communicate and interact with other users. In particular embodiments, users may join the online social network via the social-networking system 160 and then add connections (e.g., relationships) to a number of other users of the social-networking system 160 whom they want to be connected to. Herein, the term “friend” may refer to any other user of the social-networking system 160 with whom a user has formed a connection, association, or relationship via the social-networking system 160.

In particular embodiments, the social-networking system 160 may provide users with the ability to take actions on various types of items or objects, supported by the social-networking system 160. As an example and not by way of limitation, the items and objects may include groups or social networks to which users of the social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in the social-networking system 160 or by an external system of a third-party system 170, which is separate from the social-networking system 160 and coupled to the social-networking system 160 via a network 110.

In particular embodiments, the social-networking system 160 may be capable of linking a variety of entities. As an example and not by way of limitation, the social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating the social-networking system 160. In particular embodiments, however, the social-networking system 160 and third-party systems 170 may operate in conjunction with each other to provide social-networking services to users of the social-networking system 160 or third-party systems 170. In this sense, the social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, the social-networking system 160 also includes user-generated content objects, which may enhance a user's interactions with the social-networking system 160. User-generated content may include anything a user can add, upload, send, or “post” to the social-networking system 160. As an example and not by way of limitation, a user communicates posts to the social-networking system 160 from a client system 130. Posts may include data such as status updates or other textual data, location information, photos, videos, links, music or other similar data or media. Content may also be added to the social-networking system 160 by a third-party through a “communication channel,” such as a newsfeed or stream.

In particular embodiments, the social-networking system 160 may include a variety of servers, sub-systems, programs, modules, logs, and data stores. In particular embodiments, the social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. The social-networking system 160 may also include suitable components such as network interfaces, security mechanisms, load balancers, failover servers, management-and-network-operations consoles, other suitable components, or any suitable combination thereof. In particular embodiments, the social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking the social-networking system 160 to one or more client systems 130 or one or more third-party systems 170 via a network 110. The web server may include a mail server or other messaging functionality for receiving and routing messages between the social-networking system 160 and one or more client systems 130. An API-request server may allow a third-party system 170 to access information from the social-networking system 160 by calling one or more APIs. An action logger may be used to receive communications from a web server about a user's actions on or off the social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from a client system 130 responsive to a request received from a client system 130. Authorization servers may be used to enforce one or more privacy settings of the users of the social-networking system 160. A privacy setting of a user determines how particular information associated with a user can be shared. The authorization server may allow users to opt in to or opt out of having their actions logged by the social-networking system 160 or shared with other systems (e.g., a third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

### Social Graphs

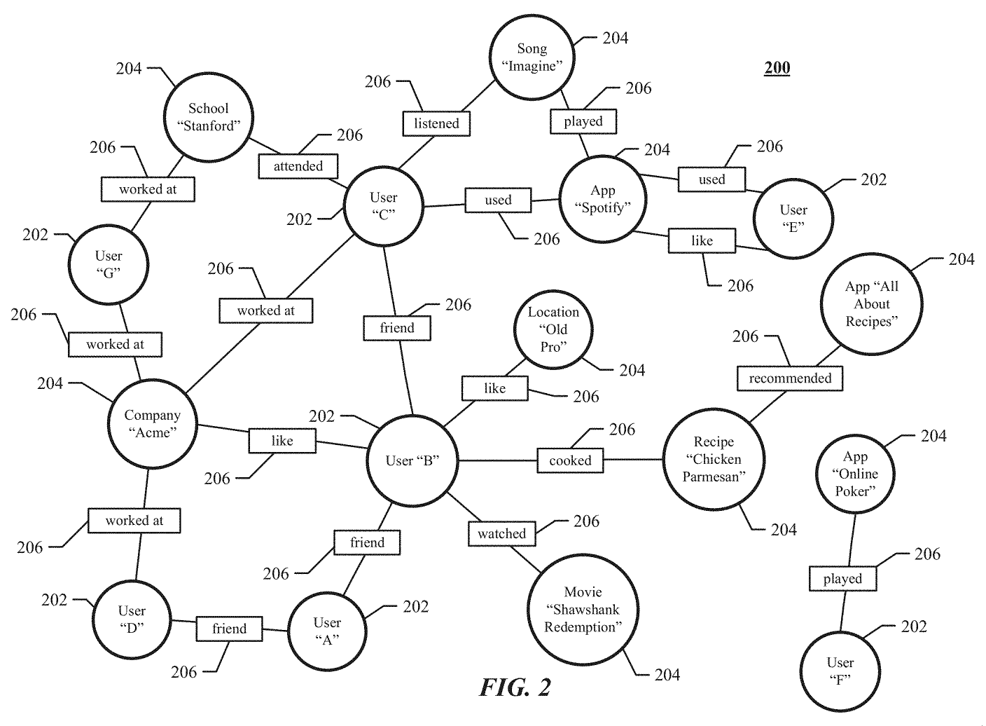

FIG. 2 illustrates an example social graph 200. In particular embodiments, the social-networking system 160 may store one or more social graphs 200 in one or more data stores. In particular embodiments, the social graph 200 may include multiple nodes—which may include multiple user nodes 202 or multiple concept nodes 204—and multiple edges 206 connecting the nodes. The example social graph 200 illustrated in FIG. 2 is shown, for didactic purposes, in a two-dimensional visual map representation. In particular embodiments, a social-networking system 160, a client system 130, or a third-party system 170 may access the social graph 200 and related social-graph information for suitable applications. The nodes and edges of the social graph 200 may be stored as data objects, for example, in a data store (such as a social-graph database). Such a data store may include one or more searchable or queryable indexes of nodes or edges of the social graph 200.

In particular embodiments, a user node 202 may correspond to a user of the social-networking system 160. As an example and not by way of limitation, a user may be an individual (human user), an entity (e.g., an enterprise, business, or third-party application), or a group (e.g., of individuals or entities) that interacts or communicates with or over the social-networking system 160. In particular embodiments, when a user registers for an account with the social-networking system 160, the social-networking system 160 may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system 160. In particular embodiments, a user node 202 may be associated with information provided by a user or information gathered by various systems, including the social-networking system 160. As an example and not by way of limitation, a user may provide his or her name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more web interfaces.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-networking system 160 or a third-party website associated with a web-application server); an entity (such as, for example, a person, business, group, sports team, or celebrity); a resource (such as, for example, an audio file, video file, digital photo, text file, structured document, or application) which may be located within the social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more web interfaces.

In particular embodiments, a node in the social graph 200 may represent or be represented by a web interface (which may be referred to as a “profile interface”). Profile interfaces may be hosted by or accessible to the social-networking system 160. Profile interfaces may also be hosted on third-party websites associated with a third-party server 170. As an example and not by way of limitation, a profile interface corresponding to a particular external web interface may be the particular external web interface and the profile interface may correspond to a particular concept node 204. Profile interfaces may be viewable by all or a selected subset of other users. As an example and not by way of limitation, a user node 202 may have a corresponding user-profile interface in which the corresponding user may add content, make declarations, or otherwise express himself or herself. As another example and not by way of limitation, a concept node 204 may have a corresponding concept-profile interface in which one or more users may add content, make declarations, or express themselves, particularly in relation to the concept corresponding to concept node 204.

In particular embodiments, a concept node 204 may represent a third-party web interface or resource hosted by a third-party system 170. The third-party web interface or resource may include, among other elements, content, a selectable or other icon, or other inter-actable object (which may be implemented, for example, in JavaScript, AJAX, or PHP codes) representing an action or activity. As an example and not by way of limitation, a third-party web interface may include a selectable icon such as “like,” “check-in,” “eat,” “recommend,” or another suitable action or activity. A user viewing the third-party web interface may perform an action by selecting one of the icons (e.g., “check-in”), causing a client system 130 to send to the social-networking system 160 a message indicating the user's action. In response to the message, the social-networking system 160 may create an edge (e.g., a check-in-type edge) between a user node 202 corresponding to the user and a concept node 204 corresponding to the third-party web interface or resource and store edge 206 in one or more data stores.

In particular embodiments, a pair of nodes in the social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system 160 may send a “friend request” to the second user. If the second user confirms the “friend request,” the social-networking system 160 may create an edge 206 connecting the first user's user node 202 to the second user's user node 202 in the social graph 200 and store edge 206 as social-graph information in one or more of data stores 164. In the example of FIG. 2, the social graph 200 includes an edge 206 indicating a friend relation between user nodes 202 of user “A” and user “B” and an edge indicating a friend relation between user nodes 202 of user “C” and user “B.” Although this disclosure describes or illustrates particular edges 206 with particular attributes connecting particular user nodes 202, this disclosure contemplates any suitable edges 206 with any suitable attributes connecting user nodes 202. As an example and not by way of limitation, an edge 206 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in the social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile interface corresponding to a concept node 204 may include, for example, a selectable “check in” icon (such as, for example, a clickable “check in” icon) or a selectable “add to favorites” icon. Similarly, after a user clicks these icons, the social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, the social-networking system 160 may create a “listened” edge 206 and a “used” edge (as illustrated in FIG. 2) between user nodes 202 corresponding to the user and concept nodes 204 corresponding to the song and application to indicate that the user listened to the song and used the application. Moreover, the social-networking system 160 may create a “played” edge 206 (as illustrated in FIG. 2) between concept nodes 204 corresponding to the song and the application to indicate that the particular song was played by the particular application. In this case, “played” edge 206 corresponds to an action performed by an external application (SPOTIFY) on an external audio file (the song “Imagine”). Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user “E” and concept node 204 for “SPOTIFY”).

In particular embodiments, the social-networking system 160 may create an edge 206 between a user node 202 and a concept node 204 in the social graph 200. As an example and not by way of limitation, a user viewing a concept-profile interface (such as, for example, by using a web browser or a special-purpose application hosted by the user's client system 130) may indicate that he or she likes the concept represented by the concept node 204 by clicking or selecting a “Like” icon, which may cause the user's client system 130 to send to the social-networking system 160 a message indicating the user's liking of the concept associated with the concept-profile interface. In response to the message, the social-networking system 160 may create an edge 206 between user node 202 associated with the user and concept node 204, as illustrated by “like” edge 206 between the user and concept node 204. In particular embodiments, the social-networking system 160 may store an edge 206 in one or more data stores. In particular embodiments, an edge 206 may be automatically formed by the social-networking system 160 in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

### Search Queries on Online Social Networks

In particular embodiments, a user may submit a query to the social-networking system 160 by, for example, selecting a query input or inputting text into query field. A user of an online social network may search for information relating to a specific subject matter (e.g., users, concepts, external content or resource) by providing a short phrase describing the subject matter, often referred to as a “search query,” to a search engine. The query may be an unstructured text query and may comprise one or more text strings (which may include one or more n-grams). In general, a user may input any character string into a query field to search for content on the social-networking system 160 that matches the text query. The social-networking system 160 may then search a data store 164 (or, in particular, a social-graph database) to identify content matching the query. The search engine may conduct a search based on the query phrase using various search algorithms and generate search results that identify resources or content (e.g., user-profile interfaces, content-profile interfaces, or external resources) that are most likely to be related to the search query. To conduct a search, a user may input or send a search query to the search engine. In response, the search engine may identify one or more resources that are likely to be related to the search query, each of which may individually be referred to as a “search result,” or collectively be referred to as the “search results” corresponding to the search query. The identified content may include, for example, social-graph elements (i.e., user nodes 202, concept nodes 204, edges 206), profile interfaces, external web interfaces, or any combination thereof. The social-networking system 160 may then generate a search-results interface with search results corresponding to the identified content and send the search-results interface to the user. The search results may be presented to the user, often in the form of a list of links on the search-results interface, each link being associated with a different interface that contains some of the identified resources or content. In particular embodiments, each link in the search results may be in the form of a Uniform Resource Locator (URL) that specifies where the corresponding interface is located and the mechanism for retrieving it. The social-networking system 160 may then send the search-results interface to the web browser 132 on the user's client system 130. The user may then click on the URL links or otherwise select the content from the search-results interface to access the content from the social-networking system 160 or from an external system (such as, for example, a third-party system 170), as appropriate. The resources may be ranked and presented to the user according to their relative degrees of relevance to the search query. The search results may also be ranked and presented to the user according to their relative degree of relevance to the user. In other words, the search results may be personalized for the querying user based on, for example, social-graph information, user information, search or browsing history of the user, or other suitable information related to the user. In particular embodiments, ranking of the resources may be determined by a ranking algorithm implemented by the search engine. As an example and not by way of limitation, resources that are more relevant to the search query or to the user may be ranked higher than the resources that are less relevant to the search query or the user. In particular embodiments, the search engine may limit its search to resources and content on the online social network. However, in particular embodiments, the search engine may also search for resources or contents on other sources, such as a third-party system 170, the internet or World Wide Web, or other suitable sources. Although this disclosure describes querying the social-networking system 160 in a particular manner, this disclosure contemplates querying the social-networking system 160 in any suitable manner.

### Typeahead Processes and Queries

In particular embodiments, one or more client-side and/or backend (server-side) processes may implement and utilize a “typeahead” feature that may automatically attempt to match social-graph elements (e.g., user nodes 202, concept nodes 204, or edges 206) to information currently being entered by a user in an input form rendered in conjunction with a requested interface (such as, for example, a user-profile interface, a concept-profile interface, a search-results interface, a user interface/view state of a native application associated with the online social network, or another suitable interface of the online social network), which may be hosted by or accessible in the social-networking system 160. In particular embodiments, as a user is entering text to make a declaration, the typeahead feature may attempt to match the string of textual characters being entered in the declaration to strings of characters (e.g., names, descriptions) corresponding to users, concepts, or edges and their corresponding elements in the social graph 200. In particular embodiments, when a match is found, the typeahead feature may automatically populate the form with a reference to the social-graph element (such as, for example, the node name/type, node ID, edge name/type, edge ID, or another suitable reference or identifier) of the existing social-graph element. In particular embodiments, as the user enters characters into a form box, the typeahead process may read the string of entered textual characters. As each keystroke is made, the frontend-typeahead process may send the entered character string as a request (or call) to the backend-typeahead process executing within the social-networking system 160. In particular embodiments, the typeahead process may use one or more matching algorithms to attempt to identify matching social-graph elements. In particular embodiments, when a match or matches are found, the typeahead process may send a response to the user's client system 130 that may include, for example, the names (name strings) or descriptions of the matching social-graph elements as well as, potentially, other metadata associated with the matching social-graph elements. As an example and not by way of limitation, if a user enters the characters “pok” into a query field, the typeahead process may display a drop-down menu that displays names of matching existing profile interfaces and respective user nodes 202 or concept nodes 204, such as a profile interface named or devoted to “poker” or “pokemon,” which the user can then click on or otherwise select thereby confirming the desire to declare the matched user or concept name corresponding to the selected node.

More information on typeahead processes may be found in U.S. patent application Ser. No. 12/763162, filed 19 Apr. 2010, and U.S. patent application Ser. No. 13/556072, filed 23 Jul. 2012, which are incorporated by reference.

In particular embodiments, the typeahead processes described herein may be applied to search queries entered by a user. As an example and not by way of limitation, as a user enters text characters into a query field, a typeahead process may attempt to identify one or more user nodes 202, concept nodes 204, or edges 206 that match the string of characters entered into the query field as the user is entering the characters. As the typeahead process receives requests or calls including a string or n-gram from the text query, the typeahead process may perform or cause to be performed a search to identify existing social-graph elements (i.e., user nodes 202, concept nodes 204, edges 206) having respective names, types, categories, or other identifiers matching the entered text. The typeahead process may use one or more matching algorithms to attempt to identify matching nodes or edges. When a match or matches are found, the typeahead process may send a response to the user's client system 130 that may include, for example, the names (name strings) of the matching nodes as well as, potentially, other metadata associated with the matching nodes. The typeahead process may then display a drop-down menu that displays names of matching existing profile interfaces and respective user nodes 202 or concept nodes 204, and displays names of matching edges 206 that may connect to the matching user nodes 202 or concept nodes 204, which the user can then click on or otherwise select thereby confirming the desire to search for the matched user or concept name corresponding to the selected node, or to search for users or concepts connected to the matched users or concepts by the matching edges. Alternatively, the typeahead process may simply auto-populate the form with the name or other identifier of the top-ranked match rather than display a drop-down menu. The user may then confirm the auto-populated declaration simply by keying “enter” on a keyboard or by clicking on the auto-populated declaration. Upon user confirmation of the matching nodes and edges, the typeahead process may send a request that informs the social-networking system 160 of the user's confirmation of a query containing the matching social-graph elements. In response to the request sent, the social-networking system 160 may automatically (or alternately based on an instruction in the request) call or otherwise search a social-graph database for the matching social-graph elements, or for social-graph elements connected to the matching social-graph elements as appropriate. Although this disclosure describes applying the typeahead processes to search queries in a particular manner, this disclosure contemplates applying the typeahead processes to search queries in any suitable manner.

In connection with search queries and search results, particular embodiments may utilize one or more systems, components, elements, functions, methods, operations, or steps disclosed in U.S. patent application Ser. No. 11/503093, filed 11 Aug. 2006, U.S. patent application Ser. No. 12/977027, filed 22 Dec. 2010, and U.S. patent application Ser. No. 12/978265, filed 23 Dec. 2010, which are incorporated by reference.

### Structured Search Queries

In particular embodiments, in response to a text query received from a first user (i.e., the querying user), the social-networking system 160 may parse the text query and identify portions of the text query that correspond to particular social-graph elements. However, in some cases a query may include one or more terms that are ambiguous, where an ambiguous term is a term that may possibly correspond to multiple social-graph elements. To parse the ambiguous term, the social-networking system 160 may access a social graph 200 and then parse the text query to identify the social-graph elements that corresponded to ambiguous n-grams from the text query. The social-networking system 160 may then generate a set of structured queries, where each structured query corresponds to one of the possible matching social-graph elements. These structured queries may be based on strings generated by a grammar model, such that they are rendered in a natural-language syntax with references to the relevant social-graph elements. As an example and not by way of limitation, in response to the text query, “show me friends of my girlfriend,” the social-networking system 160 may generate a structured query “Friends of Stephanie,” where “Friends” and “Stephanie” in the structured query are references corresponding to particular social-graph elements. The reference to “Stephanie” would correspond to a particular user node 202 (where the social-networking system 160 has parsed the n-gram “my girlfriend” to correspond with a user node 202 for the user “Stephanie”), while the reference to “Friends” would correspond to friend-type edges 206 connecting that user node 202 to other user nodes 202 (i.e., edges 206 connecting to “Stephanie's” first-degree friends). When executing this structured query, the social-networking system 160 may identify one or more user nodes 202 connected by friend-type edges 206 to the user node 202 corresponding to “Stephanie”. As another example and not by way of limitation, in response to the text query, “friends who work at facebook,” the social-networking system 160 may generate a structured query “My friends who work at Facebook,” where “my friends,” “work at,” and “Facebook” in the structured query are references corresponding to particular social-graph elements as described previously (i.e., a friend-type edge 206, a work-at-type edge 206, and concept node 204 corresponding to the company “Facebook”). By providing suggested structured queries in response to a user's text query, the social-networking system 160 may provide a powerful way for users of the online social network to search for elements represented in the social graph 200 based on their social-graph attributes and their relation to various social-graph elements. Structured queries may allow a querying user to search for content that is connected to particular users or concepts in the social graph 200 by particular edge-types. The structured queries may be sent to the first user and displayed in a drop-down menu (via, for example, a client-side typeahead process), where the first user can then select an appropriate query to search for the desired content. Some of the advantages of using the structured queries described herein include finding users of the online social network based upon limited information, bringing together virtual indexes of content from the online social network based on the relation of that content to various social-graph elements, or finding content related to you and/or your friends. Although this disclosure describes generating particular structured queries in a particular manner, this disclosure contemplates generating any suitable structured queries in any suitable manner.

More information on element detection and parsing queries may be found in U.S. patent application Ser. No. 13/556072, filed 23 Jul. 2012, U.S. patent application Ser. No. 13/731866, filed 31 Dec. 2012, and U.S. patent application Ser. No. 13/732101, filed 31 Dec. 2012, each of which is incorporated by reference. More information on structured search queries and grammar models may be found in U.S. patent application Ser. No. 13/556072, filed 23 Jul. 2012, U.S. patent application Ser. No. 13/674695, filed 12 Nov. 2012, and U.S. patent application Ser. No. 13/731866, filed 31 Dec. 2012, each of which is incorporated by reference.

### Generating Keywords and Keyword Queries

In particular embodiments, the social-networking system 160 may provide customized keyword completion suggestions to a querying user as the user is inputting a text string into a query field. Keyword completion suggestions may be provided to the user in a non-structured format. In order to generate a keyword completion suggestion, the social-networking system 160 may access multiple sources within the social-networking system 160 to generate keyword completion suggestions, score the keyword completion suggestions from the multiple sources, and then return the keyword completion suggestions to the user. As an example and not by way of limitation, if a user types the query “friends stan,” then the social-networking system 160 may suggest, for example, “friends stanford,” “friends stanford university,” “friends stanley,” “friends stanley cooper,” “friends stanley kubrick,” “friends stanley cup,” and “friends stanlonski.” In this example, the social-networking system 160 is suggesting the keywords which are modifications of the ambiguous n-gram “stan,” where the suggestions may be generated from a variety of keyword generators. The social-networking system 160 may have selected the keyword completion suggestions because the user is connected in some way to the suggestions. As an example and not by way of limitation, the querying user may be connected within the social graph 200 to the concept node 204 corresponding to Stanford University, for example by like- or attended-type edges 206. The querying user may also have a friend named Stanley Cooper. Although this disclosure describes generating keyword completion suggestions in a particular manner, this disclosure contemplates generating keyword completion suggestions in any suitable manner.

More information on keyword queries may be found in U.S. patent application Ser. No. 14/244748, filed 3 Apr. 2014, U.S. patent application Ser. No. 14/470607, filed 27 Aug. 2014, and U.S. patent application Ser. No. 14/561418, filed 5 Dec. 2014, each of which is incorporated by reference.

### Indexing Based on Object-Type

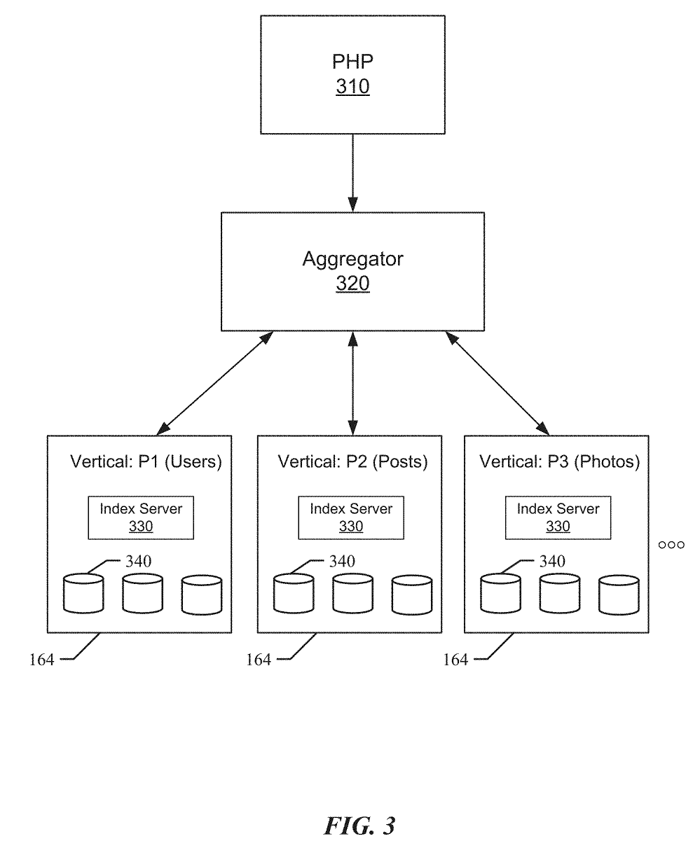

FIG. 3 illustrates an example partitioning for storing objects of social-networking system 160. A plurality of data stores 164 (which may also be called “verticals”) may store objects of social-networking system 160. The amount of data (e.g., data for a social graph 200) stored in the data stores may be very large. As an example and not by way of limitation, a social graph used by Facebook, Inc. of Menlo Park, Calif. can have a number of nodes in the order of 10⁸, and a number of edges in the order of 10¹⁰. Typically, a large collection of data such as a large database may be divided into a number of partitions. As the index for each partition of a database is smaller than the index for the overall database, the partitioning may improve performance in accessing the database. As the partitions may be distributed over a large number of servers, the partitioning may also improve performance and reliability in accessing the database. Ordinarily, a database may be partitioned by storing rows (or columns) of the database separately. In particular embodiments, a database maybe partitioned by based on object-types. Data objects may be stored in a plurality of partitions, each partition holding data objects of a single object-type. In particular embodiments, social-networking system 160 may retrieve search results in response to a search query by submitting the search query to a particular partition storing objects of the same object-type as the search query's expected results. Although this disclosure describes storing objects in a particular manner, this disclosure contemplates storing objects in any suitable manner.

In particular embodiments, each object may correspond to a particular node of a social graph 200. An edge 206 connecting the particular node and another node may indicate a relationship between objects corresponding to these nodes. In addition to storing objects, a particular data store may also store social-graph information relating to the object. Alternatively, social-graph information about particular objects may be stored in a different data store from the objects. Social-networking system 160 may update the search index of the data store based on newly received objects, and relationships associated with the received objects.

In particular embodiments, each data store 164 may be configured to store objects of a particular one of a plurality of object-types in respective data storage devices 340. An object-type may be, for example, a user, a photo, a post, a comment, a message, an event listing, a web interface, an application, a location, a user-profile interface, a concept-profile interface, a user group, an audio file, a video, an offer/coupon, or another suitable type of object. Although this disclosure describes particular types of objects, this disclosure contemplates any suitable types of objects. As an example and not by way of limitation, a user vertical P1 illustrated in FIG. 3 may store user objects. Each user object stored in the user vertical P1 may comprise an identifier (e.g., a character string), a user name, and a profile picture for a user of the online social network. Social-networking system 160 may also store in the user vertical P1 information associated with a user object such as language, location, education, contact information, interests, relationship status, a list of friends/contacts, a list of family members, privacy settings, and so on. As an example and not by way of limitation, a post vertical P2 illustrated in FIG. 3 may store post objects. Each post object stored in the post vertical P2 may comprise an identifier, a text string for a post posted to social-networking system 160. Social-networking system 160 may also store in the post vertical P2 information associated with a post object such as a time stamp, an author, privacy settings, users who like the post, a count of likes, comments, a count of comments, location, and so on. As an example and not by way of limitation, a photo vertical P3 may store photo objects (or objects of other media types such as video or audio). Each photo object stored in the photo vertical P3 may comprise an identifier and a photo. Social-networking system 160 may also store in the photo vertical P3 information associated with a photo object such as a time stamp, an author, privacy settings, users who are tagged in the photo, users who like the photo, comments, and so on. In particular embodiments, each data store may also be configured to store information associated with each stored object in data storage devices 340.

In particular embodiments, objects stored in each vertical 164 may be indexed by one or more search indices. The search indices may be hosted by respective index server 330 comprising one or more computing devices (e.g., servers). The index server 330 may update the search indices based on data (e.g., a photo and information associated with a photo) submitted to social-networking system 160 by users or other processes of social-networking system 160 (or a third-party system). The index server 330 may also update the search indices periodically (e.g., every 24 hours). The index server 330 may receive a query comprising a search term, and access and retrieve search results from one or more search indices corresponding to the search term. In some embodiments, a vertical corresponding to a particular object-type may comprise a plurality of physical or logical partitions, each comprising respective search indices.

In particular embodiments, social-networking system 160 may receive a search query from a PHP (Hypertext Preprocessor) process 310. The PHP process 310 may comprise one or more computing processes hosted by one or more servers 162 of social-networking system 160. The search query may be a text string or a search query submitted to the PHP process by a user or another process of social-networking system 160 (or third-party system 170). In particular embodiments, an aggregator 320 may be configured to receive the search query from PHP process 310 and distribute the search query to each vertical. The aggregator may comprise one or more computing processes (or programs) hosted by one or more computing devices (e.g. servers) of the social-networking system 160. Particular embodiments may maintain the plurality of verticals 164 as illustrated in FIG. 3. Each of the verticals 164 may be configured to store a single type of object indexed by a search index as described earlier. In particular embodiments, the aggregator 320 may receive a search request. For example, the aggregator 320 may receive a search request from a PHP (Hypertext Preprocessor) process 210 illustrated in FIG. 2. In particular embodiments, the search request may comprise a text string. The search request may be a structured or substantially unstructured text string submitted by a user via a PHP process. The search request may also be structured or a substantially unstructured text string received from another process of the social-networking system. In particular embodiments, the aggregator 320 may determine one or more search queries based on the received search request (step 303). In particular embodiments, each of the search queries may have a single object type for its expected results (i.e., a single result-type). In particular embodiments, the aggregator 320 may, for each of the search queries, access and retrieve search query results from at least one of the verticals 164, wherein the at least one vertical 164 is configured to store objects of the object type of the search query (i.e., the result-type of the search query). In particular embodiments, the aggregator 320 may aggregate search query results of the respective search queries. For example, the aggregator 320 may submit a search query to a particular vertical and access index server 330 of the vertical, causing index server 330 to return results for the search query.

More information on indexes and search queries may be found in U.S. patent application Ser. No. 13/560,212, filed 27 Jul. 2012, U.S. patent application Ser. No. 13/560,901, filed 27 Jul. 2012, U.S. patent application Ser. No. 13/723,861, filed 21 Dec. 2012, and U.S. patent application Ser. No. 13/870,113, filed 25 Apr. 2013, each of which is incorporated by reference.

### Query Suggestions Based on Third-Party Content Objects

In particular embodiments, the social-networking system 160 may provide a user of the online social network customized keyword query suggestions based on the user's interactions with third-party content objects. The user may conduct a search against the online social network by inputting a text query into a user interface of the social-networking system 160 (e.g., a query field). The text query may comprise one or more n-grams. In response to the user's input, the social-networking system 160 may identify or generate (e.g., via a typeahead process) a plurality of keyword query suggestions that match one or more n-grams of the text query. The keyword query suggestions may each comprise one or more keyword phrases (e.g., words, phrases, other suitable text strings), which may be obtained from a variety of sources (e.g., a name of a user or an entity on the online social network, a language database, a list of trending-topic keyword phrases, a search history associated with the user or the user's social connections). In particular embodiments, the suggested keyword queries may also comprise keyword phrases that are generated based on the querying user's recent browsing history or a record of the querying user's social activities with respect to third-party content objects (e.g., activities such as, clicking on, commenting on, liking, or sharing a link to an article that is posted on a third-party website). The social-networking system 160 may generate a plurality of candidate keyword phrases by extracting n-grams from content associated with third-party content objects that may be accessed by users of the online social network and store the candidate keyword phrases in association with the third-party content objects (e.g., as “meta tags” of the content objects). Based on a browsing history or activity log of the querying user, the social-networking system 160 may identify one or more third-party content objects recently interacted with by the querying user and access candidate keyword phrases stored in association with the identified third-party content objects. The social-networking system 160 may then generate keyword query suggestions matching one or more n-grams of the inputted text query and comprising one or more of the accessed candidate keyword phrases. The keyword query suggestions may then be provided to the querying user. Particular embodiments of the social-networking system 160 may further generate and provide one or more suggested keyword queries comprising keyword phrases that have been generated and stored in association with native content objects of the online social network (in addition to suggested keyword queries based on third-party content objects). As an example and not by way of limitation, a user may start a search against the online social network by inputting a text query, “w,” in a query field. Based on a browsing history or activity log of the querying user, the social-networking system 160 may identify a plurality of third-party content objects that the querying user has recently accessed. Among the identified third-party content objects may be an article about water on Mars that is published on a website specialized in astronomy news. This article may have been made available on the online social network via one or more URL links shared by users of the online social network. The social-networking system 160 may have extracted and stored, in association with this article, one or more n-grams or candidate keyword phrases describing the article, which may include the keyword phrase “water on mars.” Because the candidate keyword phrase “water on mars” is associated with an article recently read by the querying user and has a first letter “w” that matches the querying user's input, the social-networking system 160 may provide “water on mars” as a suggested keyword query to the querying user. As another example and not by way of limitation, a user may input a text query “final” to search the online social network. The social-networking system 160 may search a record of the querying user's social activities and identify a video about NCAA March Madness posted on a sports website, which has been shared on the online social network and liked by the querying user. The social-networking system 160 may then determine that the term “Final Four” appears in many comments that are made on the online social network about the video. Accordingly, the social-networking system 160 may then extract “final four” as a candidate keyword phrase and provide a corresponding keyword query suggestion (e.g., “final four 2016”) to the querying user. The embodiments described herein may enable the social-networking system 160 to provide suggested queries that are customized based on a user's social interactions related to third-party content objects. Although this disclosure describes providing customized keyword query suggestions related to third-party content objects in a particular manner, this disclosure contemplates providing customized keyword query suggestions related to third-party content objects in any suitable manner.

In particular embodiments, the social-networking system 160 may generate a plurality of candidate keyword phrases by extracting n-grams from content associated with third-party content objects that may be accessed by users of the online social network. The social-networking system 160 may store the extracted n-grams as candidate keyword phrases in association with the third-party content objects. A third-party content object may comprise data, such as, for example, text, photos, videos, links, music, location information, other suitable data or media, or any combination thereof. It may be stored by a third-party system 170 and be made available on the online social network via a link (e.g., a URL link). The social graph 200 may comprise a plurality of content nodes representing a plurality of third-party content objects that are made available on the online social network. Each content node may be connected to one or more user nodes 202 or concept nodes 204 by one or more edges 206 on the social graph 200. A user of the online social network may interact with a third-party content object in a plurality of ways, such as, for example, accessing the third-party content object via a link on the online social network, posting, to the online social network, a link to the third-party content object, accessing a content object of the online social network associated with the third-party content object, commenting on a content object of the online social network associated with the third-party content object, liking a content object of the online social network associated with the third-party content object, sharing a content object of the online social network associated with the third-party content object, accessing a search result from the online social network, wherein the search result references the third-party content object, another suitable way of interacting with the third-party content object, or any combination thereof. As an example and not by way of limitation, an article about water on Mars may be a third-party content object published on a third-party website. The article may be made available on the online social network via a user's post, which comprises a link to the article. Images or texts from the article may also be presented in the post. This “water on Mars” article may be published separately on more than one third-party systems and be made available on the online social network in more than one instance by different users. The post comprising the link to the “water on Mars” article may appear in a newsfeed interface of a particular user, who may then interact with the “water on Mars” article via the status update. The user may directly interact with the article by clicking on the link in the post and access the article on the third-party website. The third-party website may allow the user to perform one or more acts (e.g., leaving a comment, which may be facilitated by a social plugin allowing third-party systems 170 to use the commenting functionality of the online social network on a website hosted by the third-party system 170) with respect to the article. Alternatively, the user may indirectly interact with the article by accessing, liking, commenting on, or sharing the post comprising the link to the article on the online social network. As another example and not by way of limitation, a video about NCAA March Madness may be posted on a sports website and linked to the online social network by one or more users as a third-party content object. A particular user may have searched the online social network using the query “march madness” and received this video as a search result. The user may then interact with the video by viewing the search result or clicking on the search result to watch the video on the sports website. The querying user may further interact with the video by subsequently posting a status update on the online social network, the status update comprising a link to the video and a text string written by the querying user (e.g., a heading, a description, a comment).

In particular embodiments, the social-networking system 160 may extract, from content associated with a third-party content object that may be interacted with by users of the online social network, one or more n-grams via a machine-learning algorithm. The social-networking system 160 may then generate one or more candidate keyword phrases based on the extracted n-grams. Content associated with a third-party content object may comprise one or more of text of the third-party content object, text of another content object determined to be similar to or of the same category as the third-party content object, a descriptive tag associated with the third-party content object, text of a content object of the online social network associated with the third-party content object (e.g., text in a post or a comment), a search query associated with the third-party content object, or another suitable piece of content. The social-networking system 160 may select one or more types of content associated with the third-party content object as a corpus from which to extract n-grams. The selection of content may be based on one or more rules. As an example and not by way of limitation, the social-networking system 160 may prioritize different types of content based on their level of relevance to the third-party content object (e.g., descriptive tags may enjoy priority over search queries). As another example and not by way of limitation, the social-networking system 160 may only extract n-grams from a type of content (e.g., text of another content object determined to be similar to or of the same category as the third-party content object) when the size of the corpus is below a threshold. The social-networking system 160 may then extract one or more n-grams (e.g., n-grams describing the third-party content object) from the corpus. Extracting the n-grams may be based on a machine learning algorithm (e.g., one implementing TF-IDF analysis). As an example and not by way of limitation, the social-networking system 160 may generate a plurality of candidate keyword phrases associated with the “water on Mars” article, which is published by a third-party system 170 and made available on the online social network. The social-networking system 160 may first define a corpus from which to extract n-grams. This corpus may comprise the text of the “water on Mars” article itself. The social-networking system 160 may also determine that one or more other content objects are similar to or of the same category (e.g., science, astronomy, human habitat) of the “water on Mars” article and include text from these content objects in the corpus. The “water on Mars” article may further be associated with one or more descriptive tags (e.g., “astronomy,” “news,” “environment,” “crazy people”) on the third-party system 170 or on the online social network. The descriptive tags may be manually placed on the article by a person (e.g., a writer of the article, a poster of the article, an administrator of the third-party website). The corpus may also comprise such descriptive tags. Content objects of the online social network associated with the article may be another source from which n-grams may be extracted. The content objects may include one or more posts comprising or comments on a link to the article. The social-networking system 160 may also maintain a record of search queries and their corresponding results. It may thereby search the record and identify search queries (e.g., “water on mars”) that have returned content referencing the article as a result to be included in the corpus. The social-networking system 160 may then extract one or more n-grams from the defined corpus. For example, in relation to the “water on Mars” article, the social-networking system 160 may extract the n-gram “water on mars,” which may be the n-gram that appears most frequently in the corpus. The social-networking system 160 may also extract the n-gram “wet habitat on Mars,” which may be a descriptive tag assigned to the article by an administrator of the third-party website. The social-networking system 160 may then create one or more candidate keyword phrases corresponding to the extracted n-grams, respectively (e.g., “water on mars,” “wet habitat”). The extraction of n-grams and generation of candidate keyword phrases may not be limited to third-party content objects. The social-networking system 160 may similarly generate one or more candidate keyword phrases for a content object that is native to the online social network. The native content object may be stored in one or more data stores 164 associated with the online social network.

In particular embodiments, the social-networking system 160 may store the generated candidate keyword phrases in association with their corresponding third-party content objects. The candidate keyword phrases may be stored in data entries structured such that the relationship between each candidate keyword phrase and identification information of its corresponding third-party content object is unambiguously defined. The candidate keyword phrases may also be stored as metadata associated with the third-party content objects (e.g., as “meta tags”). In particular embodiments, the candidate keyword phrases may be stored in one or more data stores associated with the online social network. Alternatively, the candidate keyword phrases may be stored or cached on a local cache of the client system 130 of a user (e.g., a querying user). The social-networking system 160 may select and rank one or more content objects (native or third-party), information associated with which are to be cached on the client system 130 of the user. Candidate keyword phrases associated with all or a specified number of top-ranked cached content objects may be cached on the client system 130. The selection and ranking of cached content objects may be based on, for example, an affinity between the user and each content object, a social-interaction history of the user (e.g., when the user interacts with particular content objects), a search history of the user, another suitable criterion, or any combination thereof. The local cache may be associated with a web browser 132 of the client system 130. The candidate keyword phrases may be stored on the local cache when the client system 130 is turned on, a web page associated with the online social network is opened on the web browser 132, or when an application installed on the client system 130 that is associated with the online social network is opened. Keyword query suggestions associated with cached content objects may be provided to a querying user nearly instantaneously from the local cache. The stored candidate keywords may be updated periodically according to a specified schedule (e.g., once an hour). Alternatively, the stored candidate keywords may be updated dynamically based on one or more types of trigger events (e.g., a new search conducted by the user, an interaction with a particular content object). As an example and not by way of limitation, for a third-party content object that is an article about water on Mars, the social-networking system 160 may have generated one or more candidate keyword phrases associated with the article. The candidate keyword phrases may be stored in a data store 164 associated with the online social network. The social-networking system 160 may monitor social activities related to the “water on Mars” article on the online social network, particularly, language used to describe the article. Based on information obtained in relation to the social activities, the social-networking system 160 may then dynamically or periodically update the stored candidate keyword phrases. Upon a trigger event, such as a user accessing the “water on Mars” article (e.g., via a web browser 132), the social-networking system 160 may send information associated with the article, which may comprise the candidate keyword phrases, to the client system 130 to be stored on a local cache. Such information may be removed from the client system 130 or be replaced by information associated with other content objects after a specified amount of time or upon a specified trigger event (e.g., the user interacting with the other content objects).

In particular embodiments, the candidate keyword phrases may be pre-generated by an auto-suggestion system prior to a user interacting with one or more third-party content objects. The auto-suggestion system may be associated with the social-networking system 160 or a third-party system 170. The auto-suggestion system may search through third-party content objects that are made available on the online social network, which may or may not have been interacted with by particular users. It may pre-generate candidate keyword phrases in association with the third-party content objects and stored them in one or more data stores 164 associated with the online social network. The pre-generated candidate keyword phrases may then be provided to users who interact with their corresponding third-party content objects in a timely manner whenever the interactions occur. In particular alternative embodiments, the candidate keyword phrases associated with a particular third-party content object may be generated when a user interacts with the content object. The time required for generating the candidate keyword phrases in real time, however, may affect the performance of the social-networking system 160 and the corresponding user experience. As an example and not by way of limitation, the social-networking system 160 may determine that the “water on Mars” article has been published on a third-party website and shared on the online social network. It may immediately generate, via the auto-generation system, one or more candidate keyword phrases and store them in association with the article. Subsequently, it may retrieve the stored candidate keyword phrases whenever a user interacts with the “water on Mars” article and send the data to a client system 130 of the user if necessary or desirable. As another example and not by way of limitation, the social-networking system 160 may not have pre-generated candidate keyword phrases in association with the “water on Mars” article. In this case, it may generate such candidate keyword phrases in real time when a user interacts with the article. The candidate keyword phrases may then be stored and provided to the user in a search instance. However, even in this example, the stored candidate keyword phrases may be ready for use by one or more other users, who may interact with the “water on Mars” article subsequently. Although this disclosure describes generating and storing candidate keyword phrases in a particular manner, this disclosure contemplates generating and storing candidate keyword phrases in any suitable manner.

In particular embodiments, the social-networking system 160 may receive a text query from a client system 130 of a user of the online social network. The text query may comprise one or more n-grams inputted by the user. The text query may be an unstructured text query. The text query may be entered, for example, into a query field 410. The query field 410 may be presented to the user via a webpage displayed by a web browser 132 on the user's client system 130 or via an application associated with the online social network installed on the user's client system 130. The text query comprising n-grams inputted by the user may be transmitted from the user's client system 130 to the social-networking system 160 via the network 110. As an example and not by way of limitation, the social-networking system 160 may start providing suggested keyword queries to a user as soon as it receives the n-gram “w” from the user. As another example and not by way of limitation, the social-networking system 160 may receive a text query “final four” from a user. The text query may comprise at least the n-grams “final,” “four,” and “final four.” Although this disclosure describes receiving particular queries in a particular manner, this disclosure contemplates receiving any suitable queries in any suitable manner.

In particular embodiments, the social-networking system 160 may identify a set of candidate keyword phrases matching the one or more n-grams of the text query received from the user. Each candidate keyword phrase in the set may comprise one or more n-grams extracted from content associated with a third-party content object interacted with by the user. In response to a text query received from a user, the social-networking system 160 may access a social-interaction history of the user to identify one or more third-party content objects interacted with by the user. Access to the user's social-interaction history may be subject to one or more privacy settings of the user. In particular embodiments, the social-networking system 160 may only identify or select third-party content objects that have been interacted with by the user within a specified timeframe (e.g., the past ten minutes, the past one day). The timeframe may be pre-determined or determined in real time. It may depend on a pattern of use associated with the user (e.g., a frequency of interacting with third-party content objects), a characteristic of the content objects (e.g., a number of n-grams associated with each content object), a partial query inputted by the user (e.g., wider range of time for a more specific and narrower partial query), another suitable factor, or any combination thereof. The social-networking system 160 may then access one or more data stores storing n-grams or candidate keyword phrases associated with the identified third-party content objects. If no n-grams or candidate keyword phrases are stored in association with a particular third-party content object, the social-networking system 160 may extract one or more n-grams and generate a set of candidate keyword phrases in association with the third-party content object in real time. In particular embodiments, the social-networking system 160 may aggregate the candidate keyword phrases that are stored or generated in association with the identified third-party content objects into a pool. It may then identify, from the pool of candidate keyword phrases, those that match one or more n-grams received from the querying user. In particular embodiments, the pool of candidate keyword phrases may not be limited to those associated with third-party content objects. Candidate keyword phrases may also be similarly generated based on n-grams extracted from native content objects. The social-networking system 160 may identify an additional set of candidate keyword phrases matching one or more n-grams of the inputted text query. Each of this additional set of candidate keyword phrases comprises one or more n-grams extracted from content associated with a native content object interacted with by the querying user. The native content object may be stored in a data store 164 associated with the online social network. As an example and not by way of limitation, the social-networking system 160 may receive a text query “w” from a user. This simple text query may only comprise the n-gram “w.” In response, the social-networking system 160 may access a social-interaction history associated with the querying user, which may comprise at least, for each social interaction of the querying user included in the history, information about a content object interacted with and a time corresponding to the interaction. It may then identify all third-party content objects interacted with by the querying user within, for example, the past ten minutes. For example, the identified third-party content objects may include three articles about water on Mars, NASA's journey to Mars, the Mars Reconnaissance Orbiter, respectively. The social-networking system 160 may then access one or more data stores storing candidate keyword phrases associated with the identified articles and aggregate all such candidate keyword phrases into a pool. The social-networking system 160 may subsequently filter through the pool of candidate keyword phrases and identify those that start with the letter “w” (e.g., “water on mars,” “wet habitat on mars,” “weather of mars”), which all match the inputted text query. As another example and not by way of limitation, the social-networking system 160 may receive a text query “final four” from a user. This text query may comprise the n-grams “final,” “four,” and “final four.” The social-networking system 160 may access a social-interaction history associated with the querying user and determine that, within the past hour, the querying user has watched a video posted on the online social network about NCAA March Madness and commented on a status update posted by another user about her experience watching the North Carolina v. Villanova game, which comprises a link to a piece of news about the game. The social-networking system may then access one or more data stores storing candidate keyword phrases associated with the video and the news piece and identify one or more candidate keyword phrases matching one or more n-grams of the text query (e.g., “final four 2016,” “final four tv schedule,” “ncaa finals,” “game april fourth”). Although this disclosure describes identifying a set of candidate keyword phrases in a particular manner, this disclosure contemplates identifying a set of candidate keyword phrases in any suitable manner.

In particular embodiments, the social-networking system 160 may calculate a rank for each of the identified candidate keyword phrases based on one or more factors. These factors may include a social-interaction history of the querying user or another user, recency, language features, repetition, other suitable factors, or any combination thereof. The calculated rank may be a function of any combination of the factors described above or any other suitable factor on which the ranking may be based. As an example and not by way of limitation, the function for calculating a rank may be represented by the following expression: f (m₁, m₂, m₃), where m₁, m₂, and m₃ are three different factors. The calculated rank may alternatively be a sum of different functions that may be weighted in a suitable manner (e.g., the weights being pre-determined by the social-networking system 160). As an example and not by way of limitation, the function for calculating a rank may be represented by the following expression: A f₁(m₁, m₂)+B f₂(m₃), where m₁, m₂, and m₃ are three different factors, and where A and B are two different weights. The calculated rank may also involve dependence of one factor on another. As an example and not by way of limitation, the function for calculating a rank may be represented by the following expression: A U(f₁(m₁)) f₂(m₂)+B f₃(m₃), where m₁, m₂, and m₃ are three different factors, and where A and B are two different weights. In this expression, the dependence of the factor m₂ on the factor m₁ is represented by a unit step function U(f₁(m₁)). Although this disclosure describes calculating ranks in a particular manner, this disclosure contemplates calculating ranks in any suitable manner.

In particular embodiments, the social-networking system 160 may calculate a rank for each of the identified candidate keyword phrases based at least in part on a social-interaction history of the querying user. A number of candidate keyword phrases that are identified to match one or more n-grams of the inputted text query may exceed a number of keyword query suggestions that can be provided to a querying user in a particular search instance. This may necessitate ranking the candidate keyword phrases, such that one or more candidate keyword phrases (e.g., those determined to be most helpful or relevant) may be selected to be presented to the querying user. The rank for each candidate keyword phrase may correspond to a priority for being presented to a querying user as part of a keyword query suggestions. A candidate keyword phrase with a higher rank may be more likely to be suggested to a querying user or be presented in a more noticeable position of a user interface associated with the online social network than a candidate keyword phrase with a lower rank. Calculating the rank for each candidate keyword phrase may be based on a variety of factors, including, for example, a social-interaction history of the querying user or another user, recency, language features, repetition, other suitable factors, or any combination thereof. In particular embodiments, the social-interaction history of the querying user may comprise one or more online interactions of the user. The online interactions may comprise one or more of accessing a third-party content object via a link on the online social network, posting, to the online social network, a link to a third-party content object, accessing a content object of the online social network associated with a third party content object, commenting on a content object of the online social network associated with a third-party content object, liking a content object of the online social network associated with a third-party content object, sharing a content object of the online social network associated with a third-party content object, accessing a search result from the online social network wherein the search result references a third-party content object, or another suitable online interaction. The social-interaction history may be used both to prioritize candidate keyword phrases associated with different content objects and to specifically distinguish the ranks of different candidate keyword phrases associated with the same content object. The social-networking system 160 may access one or more data stores 164 to obtain the querying user's social-interaction history. The social-interaction history may be stored as a browsing history or activity log. In particular embodiments, the social-interaction history of the querying user may comprise clickstream data of the user, the clickstream data comprising information about one or more online interactions of the user with one or more third-party content objects. The clickstream data may be obtained from a third-party system 170 with appropriate privacy permissions. The social-interaction history may be filtered based on one or more factors, such as a specified timeframe. As an example and not by way of limitation, the social-networking system 160 may have generated two candidate keyword phrases “water on mars” and “wet habitat on mars” that are associated with an article interacted with by a querying user. Both candidate keyword phrases may have been generated based on n-grams directly extracted from the content of the article. The querying user may have accessed the article through a link posted on the online social network. In addition, the querying user may also have shared the link to the article on the online social network and commented on the shared link “Here is an article about water on Mars!” Based on a social-interaction history of the querying user, the social-networking system 160 may rank “water on mars” higher than “wet habitat on mars” for at least two reasons. The first reason may be that the querying user has interacted with “water on mars” (e.g., access and comment) for more times than with “wet habitat” (e.g., just access). The second reason may be that mentioning a particular candidate keyword phrase in a comment (which may indicate more engagement of the user than merely accessing an article) may be treated as a preferred way of interaction in ranking the candidate keyword phrases. Continuing the preceding example and not by way of limitation, the social-networking system 160 may have also generated the candidate keyword phrase “winner of 2016 march madness” that is associated with an video watched by the querying user. The querying user may not only have watched the video but also have liked and commented on a post by another user about this video and posted a status update to the online social network with a link to the video. Furthermore, the querying user may also have recently searched “ncaa march madness” which returned this video. The social-networking system may therefore rank the candidate keyword phrase “winner of 2016 march madness” higher than both “water on mars” and “wet habitat on mars” because the user's interactions with the third-party content object, based on which “winner of 2016 march madness” was generated, are more extensive.

In particular embodiments, the social-networking system 160 may calculate the rank for each identified candidate keyword phrase further based on a social-interaction history of a friend of the querying user on the online social network or a user of the online social network determined to be similar to the querying user. A social-interaction history of a user other than the querying user may be used in limited occasions (e.g., when the querying user has few social interactions recently, the querying user has one or more privacy settings prohibiting the access to her social-interaction history) or be used regularly. A user of the online social network may be determined to be similar to the querying user with respect to one or more of a plurality of factors (e.g., location, language spoken, interest, alma mater). As an example and not by way of limitation, the social-networking system 160 may have generated the candidate keyword phrases “water on mars” and “wet habitat on mars” from an article published on a third-party website that was interacted with by a querying user. The article may not mention either “water on mars” or “wet habitat on mars.” Both n-grams were extracted from posts of the online social network comprising links to the article. Among the posts comprising “water on mars,” several were added to the online social network by friends of the querying user. On the other hand, none of the posts comprising “wet habitat on mars” were created by friends of the querying user. The social-networking system 160 may then rank “water on mars” higher than “wet habitat on mars” with respect to the querying user because the querying user's friends have more interactions with the former than the latter. Continuing the preceding example and not by way of limitation, the social-networking system 160 may have also generated the candidate keyword phrase “winner of 2016 march madness” in association with a video watched by the querying user. The social-networking system may access social-interaction histories of users determined to be similar to the querying user, including those who attended the same college as the querying user. The college may happen to have a strong basketball team. Therefore, a lot of its alumni have interacted with the video based on which “winner of 2016 march madness” was generated. Based on this information, the social-networking system 160 may up-rank “winner of 2016 march madness” with respect to “water on mars” and “wet habitat on mars,” assuming the “water on Mars” article does not attract a comparable level of attention among users similar to the querying user.

In particular embodiments, the social-networking system 160 may calculate the rank for each identified candidate keyword phrase further based on a time decay factor. The time decay factor may be associated with an online interaction of the querying user associated with the content object from which the n-grams corresponding to the candidate keyword phrase were extracted. A candidate keyword phrase generated in association with a content object that is more recently interacted with by a querying user may be up-ranked. The social-networking system 160 may access a browsing history or social activity log of the querying user and determine when the querying user interacted with the content object associated with each identified candidate keyword phrase. The time of interaction may affect the rank of a particular candidate keyword phrase continuously (e.g., the more recent the higher the rank) or discretely (e.g., considering any interaction within a specified timeframe recent and otherwise old). The timeframe related to ranking may be pre-determined or determined in real time. It may depend on a pattern of use associated with the user (e.g., a frequency of interacting with third-party content objects), a characteristic of the content objects (e.g., a number of n-grams associated with each content object), a partial query inputted by the user (e.g., wider range of time for a more specific and narrower partial query), another suitable factor, or any combination thereof. As an example and not by way of limitation, the social-networking system 160 may have generated candidate keyword phrases “water on mars” and “winner of 2016 march madness” based on the “water on Mars” article and the “NCAA March Madness” video, respectively. The social-networking system 160 may access a social-interaction history of the querying user with proper privacy permission and determine that the user is very active on the online social network. It may then set a time period of ten minutes as the critical value in defining whether an interaction is recent. From the social-interaction history, it may further determine that the querying user interacted with the “water on Mars” article about one minute ago and the “NCAA March Madness” video fifteen minutes ago. It may thereby up-rank the candidate keyword phrase “water on mars” with respect to “winner of 2016 march madness” for at least two alternative reasons. The first possible reason may simply be that the interaction with the “water on Mars” article is more recent than the interaction with the “NCAA March Madness” video. The second possible reason may be that the interaction with the “water on Mars” article is defined as being recent because it is within the specified timeframe of ten minutes, while the interaction with the “NCAA March Madness” video is not defined as being recent.

In particular embodiments, the social-networking system 160 may calculate the rank for each identified candidate keyword phrase further based on analysis of the candidate keyword phrase according to a language model. The social-networking system 160 may weigh the strength of each candidate keyword phrase based on one or more factors considered by the language model (e.g., a TF-IDF score). Each candidate keyword phrase may also be assigned a score that affect its rank based on the level of matching between the candidate keyword phrase and one or more n-grams inputted by the querying user. Furthermore, the social-networking system 160 may calculate the rank for each identified candidate keyword phrase by determining that a first candidate keyword phrase comprises an n-gram appearing in content associated with more than one third-party content objects interacted with by the querying user, calculating a number of third-party content objects interacted with by the querying user that comprise the n-gram, and up-ranking the first candidate keyword phrase based on the calculated number of third-party content objects. In other words, the social-networking system 160 may rank the identified candidate keyword phrases based on a redundancy or repetition associated with each. As an example and not by way of limitation, in response to an inputted text query “w,” the social-networking system may identify “water on mars” and “wind on mars” as candidate keyword phrases. Based on a language model using a plurality of content objects of the online social network as training data, “water on mars” may be determined to be stronger than “wind on mars” (e.g., because the string “water on mars” appears more frequently in the training data set than “wind on mars.”). The social-networking system 160 may thereby calculate a higher rank for “water on mars” than “wind on mars.” In addition, the social-networking system 160 may have identified multiple third-party articles recently interacted with by the querying user. It may further determine that the phrase “water on mars” appears in content associated with more than one such articles (e.g., 5 articles) while the phrase “wind on mars” only appears in one of the articles. The social-networking system 160 may thereby calculate a higher rank for “water on mars” than for “wind on mars” based on the former's repetition. As another example and not by way of limitation, in response to an inputted text query “final four,” the social-networking system 160 may identify “final four 2016” and “ncaa finals” as candidate keyword phrases. It may calculate a higher rank for “final four 2016” than “ncaa finals” because the former is assigned a superior matching score with respect to the inputted text query. Although this disclosure describes calculating a rank for each of the identified candidate keyword phrases in a particular manner, this disclosure contemplates calculating a rank for each of the identified keyword phrases in any suitable manner.

In particular embodiments, the social-networking system 160 may send, to the client system 130 of the querying user for display in response to the querying user inputting the one or more n-grams of the text query, one or more suggested queries. At least one of the suggested queries may comprise one of the identified candidate keyword phrases associated with a third-party content object having a rank higher than a threshold rank. The social-networking system 160 may generate one or more keyword query suggestions based on top-ranked candidate keyword phrases. A suggested keyword query may be generated locally on the client system 130 of the querying user and be made available for display on the client system 130. Alternatively, the suggested keyword query may be generated on a server 162 associated with the social-networking system 160 and be sent to the client system 130 of the querying user for display over a network 110. These keyword query suggestions may then be provided to the querying user along with query suggestions generated based on other sources (e.g., a name of a user or an entity on the online social network, a language database, a list of trending-topic keyword phrases, a search history associated with the querying user or the querying user's social connections). All query suggestions may be ranked collectively and provided to the user via the typeahead process. Doing so may allow the querying user to receive a relatively comprehensive set of query suggestions. In particular embodiments, a suggested keyword query may be sent for display on a webpage associated with the online social network accessed by a browser client 132 on the client system 130 of the querying user. The suggested keyword query may alternatively be displayed in a user interface associated with an application corresponding to the social-networking system 160 that is installed on the client system 130 of the querying user. As an example and not by way of limitation, the social-networking system 160 may have caused a querying user's client system 130 to cache a set of candidate keyword phrases associated with a third-party article about water on Mars, including the candidate keyword phrase “water on Mars.” After the user typed “w” in a query field provided by an application installed on the user's client system 130, the social-networking system 160 may identify the candidate keyword phrase “water on mars” as one matching the inputted text query. It may then instruct the application to generate a suggested keyword query “water on mars news.” The application may then provide this suggested keyword query along with other suggested queries, in a ranked manner, to the querying user by displaying it in the application's user interface. As another example and not by way of limitation, the social-networking system 160 may have stored the candidate keyword phrase “final four 2016” in association with a video about NCAA March Madness in a data store 164 associated with the online social network. A querying user may type “final four” in a query field rendered by a browser client 132 on the querying user's client system 130. This text query may then be sent to a server 162 of the social-networking system 164. The social-networking system 164 may then identify the candidate keyword phrase “final four 2016” as matching the inputted text query and generate a corresponding suggested keyword query. It may then send the suggested keyword query to the client system 130 of the querying user for display via the browser client 132. Although this disclosure describes sending suggested queries for display in a particular manner, this disclosure contemplates sending suggested queries for display in any suitable manner.

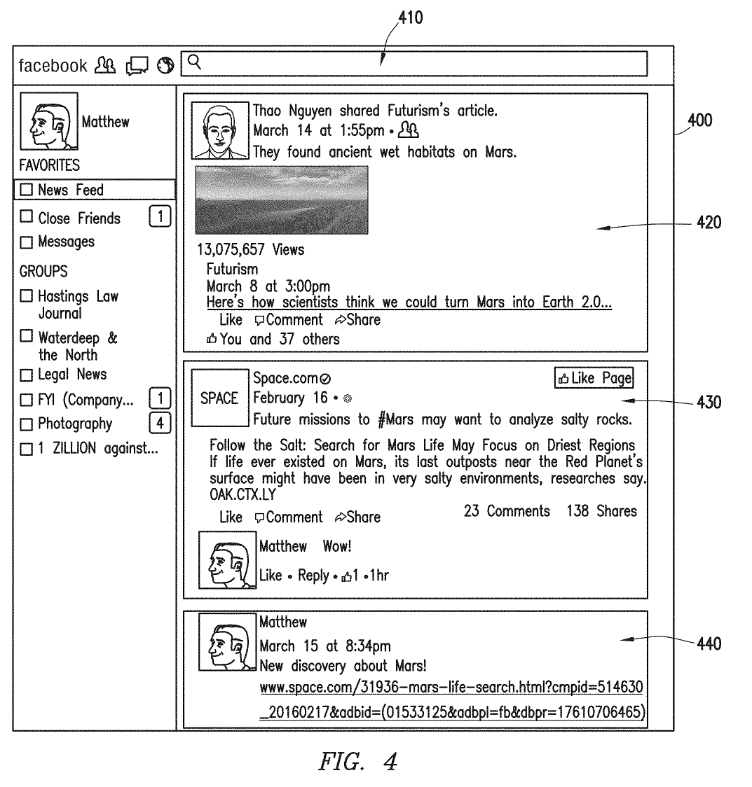

FIG. 4 illustrates an example newsfeed interface for displaying content associated with third-party content objects. In particular embodiments, the social-networking system 160 may provide a user (e.g., Matthew) a newsfeed interface 400, which may display, for the user to view and access, a plurality of content objects. Although only content objects 420, 430, and 440 are included in FIG. 4 for illustration purposes, the newsfeed interface 400 may comprise more content objects of a variety of types. Content object 420 may be posted by a friend of the user on the online social network. It may be a sharing of an article (e.g., “the Futurism article”) published on a third-party website (e.g., Futurism.com). The content object 420 may comprise an image and text excerpt (e.g., “Here's how . . . ” which is underlined to indicate a hyperlink) from the original article and a description written by the friend (e.g., “They found . . . ”). The user may directly interact with this article by, for example, clicking on the hyperlinked text to access the article. The user may indirectly interact with this article by, for example, liking the content object 420. The content object 430 may be a post created by an entity of the online social network (e.g., Space.com). It may comprise a link to an article (e.g., “the Space.com article”) published on a third-party website (e.g., Space.com), a title (e.g., “Follow the Salt: Search for Mars Life May Focus on Driest Regions”), an excerpt (e.g., “If life ever . . .”) from the original article, and a description written by the creator (e.g., “Future missions to . . . ”). The user may directly interact with this third-party article by, for example, clicking on the title, which links to the article on Space.com. The user may indirectly interact with this article by, for example, leaving a comment (e.g., “Wow!”) about it. Furthermore, the user may also indirectly interact with this third-party article by creating a post 440 comprising a link to the article. The post 440 may also comprise a description (e.g., “New discovery . . . ”) created by the user. The user's interactions with the third-party articles may be detected and recorded by the social-networking system 160 and compiled as part of the user's social-interaction history, which may later be used to rank candidate keyword phrases. The social-networking system 160 may generate one or more candidate keyword phrases by extracting n-grams from content associated with each of the two example third-party articles. For example, for the Futurism article, the corpus from which the social-networking system 160 may extract n-grams may comprise text of the article, text of the content object 420, and related content otherwise accessible to the social-networking system 160 (e.g., descriptive tags, search queries). Similarly, for the Space.com article, the corpus from which the social-networking system 160 may extract n-grams may include text of the article, text of the content objects 430 and 440, any comments on the content objects 430 and 440, and related content otherwise accessible to the social-networking system 160. Furthermore, the social-networking system 160 may determine that the two example third-party articles, both being about Mars, are similar to each other. It may thereby include text of the articles in each other's corpus, from which n-grams are extracted (e.g., extract “Earth 2.0” from the Futurism article and use it as a candidate keyword phrase associated with the Space.com article). Although FIG. 4 illustrates displaying and interacting with particular content associated with third-party content objects in a particular manner, this disclosure contemplates displaying and interacting with any suitable content associated with third-party content objects in any suitable manner.

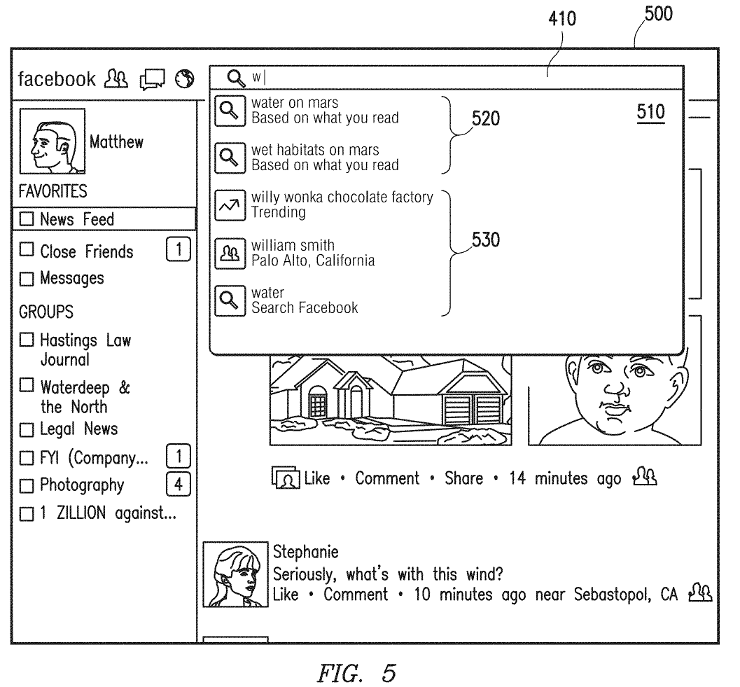

FIG. 5 illustrates an example newsfeed interface for displaying suggested queries. The newsfeed interface 500 may comprise a query field 410 for a user to input text queries. In this example, the user may input a letter “w” in the query field. In response to user's search attempt, the social-networking system 160 may access the user's social-interaction history and identify one or more third-party content objects recently interacted with by the user, which may include the Futurism article and the Space.com article corresponding to content objects 420 and 430 respectively. The social-networking system 160 may have generated a plurality of candidate keyword phrases associated with the articles and identified one or more such keyword phrases matching the inputted text query, which may include “water on mars” and “wet habitat on mars.” Keyword query suggestions 520 corresponding to the identified candidate keyword phrases may then be generated and provided to the user in a dropdown menu 510. Below each keyword query suggestion 520 may be a short description of the source of the suggestion (e.g., “Based on what you read”). The dropdown menu may further comprise one or more query suggestions 530 that were generated based on other sources (e.g., trending topics, location, general language database) associated with the online social network. Although FIG. 5 illustrates displaying particular query suggestions in a particular manner, this disclosure contemplates displaying any suitable query suggestions in any suitable manner.

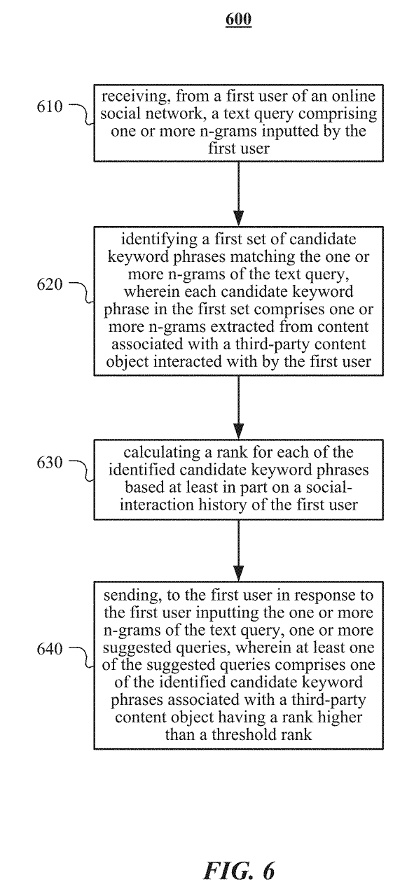

FIG. 6 illustrates an example method 600 for providing customized keyword query suggestions related to third-party content objects. The method may begin at step 610, where the social-networking system 160 may receive, from a first user of an online social network, a text query comprising one or more n-grams inputted by the first user. At step 620, the social-networking system 160 may identify a first set of candidate keyword phrases matching the one or more n-grams of the text query, wherein each candidate keyword phrase in the first set comprises one or more n-grams extracted from content associated with a third-party content object interacted with by the first user. At step 630, the social-networking system 160 may calculate a rank for each of the identified candidate keyword phrases based at least in part on a social-interaction history of the first user. At step 640, the social-networking system 160 may send, to the first user in response to the first user inputting the one or more n-grams of the text query, one or more suggested queries, wherein at least one of the suggested queries comprises one of the identified candidate keyword phrases associated with a third-party content object having a rank higher than a threshold rank. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for providing customized keyword query suggestions related to third-party content objects including the particular steps of the method of FIG. 6, this disclosure contemplates any suitable method for providing customized keyword query suggestions related to third-party content objects including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Social Graph Affinity and Coefficient

In particular embodiments, the social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, the social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile interfaces, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, the social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, the social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, the social-networking system 160 may calculate a coefficient based on a user's actions. The social-networking system 160 may monitor such actions on the online social network, on a third-party system 170, on other suitable systems, or any combination thereof. Any suitable type of user actions may be tracked or monitored. Typical user actions include viewing profile interfaces, creating or posting content, interacting with content, tagging or being tagged in images, joining groups, listing and confirming attendance at events, checking-in at locations, liking particular interfaces, creating interfaces, and performing other tasks that facilitate social action. In particular embodiments, the social-networking system 160 may calculate a coefficient based on the user's actions with particular types of content. The content may be associated with the online social network, a third-party system 170, or another suitable system. The content may include users, profile interfaces, posts, news stories, headlines, instant messages, chat room conversations, emails, advertisements, pictures, video, music, other suitable objects, or any combination thereof. The social-networking system 160 may analyze a user's actions to determine whether one or more of the actions indicate an affinity for subject matter, content, other users, and so forth. As an example and not by way of limitation, if a user may make frequently posts content related to “coffee” or variants thereof, the social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile interface for the second user.

In particular embodiments, the social-networking system 160 may calculate a coefficient based on the type of relationship between particular objects. Referencing the social graph 200, the social-networking system 160 may analyze the number and/or type of edges 206 connecting particular user nodes 202 and concept nodes 204 when calculating a coefficient. As an example and not by way of limitation, user nodes 202 that are connected by a spouse-type edge (representing that the two users are married) may be assigned a higher coefficient than a user nodes 202 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, the social-networking system 160 may determine that the user has a higher coefficient with respect to the first photo than the second photo because having a tagged-in-type relationship with content may be assigned a higher weight and/or rating than having a like-type relationship with content. In particular embodiments, the social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, the social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 200. As an example and not by way of limitation, social-graph entities that are closer in the social graph 200 (i.e., fewer degrees of separation) may have a higher coefficient than entities that are further apart in the social graph 200.

In particular embodiments, the social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, the social-networking system 160 may determine that the user has a higher coefficient for the airport than the gas station based on the proximity of the airport to the user.

In particular embodiments, the social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, the social-networking system 160 may provide information that is relevant to user's interests and current circumstances, increasing the likelihood that they will find such information of interest. In particular embodiments, the social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, the social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results interface than results corresponding to objects having lower coefficients.

In particular embodiments, the social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, the social-networking system 160 may calculate the coefficient (or access the coefficient information if it has previously been calculated and stored). In particular embodiments, the social-networking system 160 may measure an affinity with respect to a particular process. Different processes (both internal and external to the online social network) may request a coefficient for a particular object or set of objects. The social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632869, filed 1 Oct. 2012, each of which is incorporated by reference.

### Privacy

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile interface that identify a set of users that may access the work experience information on the user-profile interface, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 204 corresponding to a particular photo may have a privacy setting specifying that the photo may only be accessed by users tagged in the photo and their friends. In particular embodiments, privacy settings may allow users to opt in or opt out of having their actions logged by the social-networking system 160 or shared with other systems (e.g., a third-party system 170). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 170, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers 162 may be authorization/privacy servers for enforcing privacy settings. In response to a request from a user (or other entity) for a particular object stored in a data store 164, the social-networking system 160 may send a request to the data store 164 for the object. The request may identify the user associated with the request and may only be sent to the user (or a client system 130 of the user) if the authorization server determines that the user is authorized to access the object based on the privacy settings associated with the object. If the requesting user is not authorized to access the object, the authorization server may prevent the requested object from being retrieved from the data store 164, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In particular embodiments, privacy settings may be determined for particular types of objects associated with a user. As an example and not by way of limitation, different privacy settings may be set for different types of content that are shared by a user. As an example and not by way of limitation, a first user may specify that their status updates are public, but any images shared by the first user are only visible to the first user's friends on social-networking system 160. As another example and not by way of limitation, a user may specify different privacy settings for different types of entities, such as individual users, friends-of-friends, followers, user groups, or corporate entities. As an example and not by way of limitation, a first user may specify a group of users who may view videos posted by the first user, while keeping the videos from being visible by his or her employer. In particular embodiments, different privacy settings may be provided for different user groups or user demographics. As an example and not by way of limitation, a first user may specify that other users that attend the same university as the first user may view the first user's pictures, but that other users comprising the first user's family may not view those same pictures.

In particular embodiments, social-networking system 160 may provide a default privacy setting with respect to each type of object, and the user may edit any or all of the privacy settings. In particular embodiments, changes to privacy settings may take effect retroactively, affecting the visibility of objects and content shared prior to the change. As an example and not by way of limitation, a first user may share a first image, and specify that the first image is to be public to all other users. At a later time, the first user may specify that any images shared by the first user should be made only visible to a first user group. Social-networking system 160 may determine that this privacy setting also applies to the first image, and make the first image only visible to the first user group. In particular embodiments, the change in privacy settings may only take effect going forward. Continuing the example above, if the first user changes privacy settings then shares a second image, the second image may only be visible to the first user group, but the first image may remain visible to all users.

In particular embodiments, privacy settings for a first user may affect how the first user is able to view content associated with second users. As an example and not by way of limitation, a first user may view a number of posts, status updates, or other content uploaded to social-networking system 160 by a second user. In particular embodiments, the first user may wish to view fewer posts related to the second user, without altering the edge connection between them (e.g. the first user wishes to remain friends with the second user). In particular embodiments, the visibility of a particular second user's posts to the first user may be based on the social affinity between the first user and the second user. In particular embodiments, if the first user indicates that he or she wishes to view fewer posts of the second user, social-networking system 160 may adjust the social affinity coefficient of the second user with respect to the first user. In particular embodiments, this may reduce the frequency of posts of the second user appearing in the first user's newsfeed. As an example and not by way of limitation, if the first user indicates that he or she wishes to view fewer posts by the second user, social-networking system 160 may adjust the affinity coefficient of the first user with respect to the second user to zero, which may reset the relationship between the first user and the second user to baseline levels.

In particular embodiments, privacy settings may be based on one or more nodes or edges of a social graph 200. In particular embodiments, a privacy setting may be determined for a particular edge of social graph 200, or with respect to a particular node of social graph 200. As an example and not by way of limitation, a first user may share a content item to social-networking system 160. The content item may be associated with a concept node 204 connected to a user node 202 of the first user by an edge 206. The first user may specify privacy settings which may apply to the particular edge 206 connecting to the concept node 204 of the content item. In particular embodiments, the privacy settings applied to the particular edge 206 may govern the content item's visibility to other users associated with the first user.

In particular embodiments, a user may specify privacy settings for particular edge types. As an example and not by way of limitation, social-networking system 160 may recognize that all edges 206 connecting a user node 202 to concept nodes 204 corresponding to video content are a single edge type. The user of user node 202 may specify that all videos associated with the user should be under particular privacy settings. Social-networking system 160 may then apply the privacy settings to each edge 206 connecting user node 202 to all concept nodes 204 comprising video. As another example and not by way of limitation, a first user may share an image depicting a plurality of other users, and the sharing may include tags indicating the other users depicted in the image. The first user may specify privacy settings wherein only the other users tagged in the image are able to view the image, while the image remains hidden from users who are not tagged in the image.

In particular embodiments, the user's privacy settings may be applied to a concept node 204 of the content item directly. As an example and not by way of limitation, a user may provide privacy settings for a content item having a concept node 204. The privacy settings may specify that no other user of social-networking system 160 is permitted to view the content item. This setting may be applied to all potential edges 206 connecting to the concept node 204 of the content item, so that even if other users were to establish edge connections with the content item, they would not be able to view the content item.

In particular embodiments, a user may specify privacy settings for a particular object where the object may be sent to another user or entity, without social-networking system 160 having access to the object. As an example and not by way of limitation, a first user of social-networking system 160 may wish to send content to a second user, without any other users or social-networking system 160 having access to the content. In particular embodiments, social-networking system 160 may have access to the object temporarily in order to send the object through social-networking system 160 to the recipient. In particular embodiments, a user may provide privacy settings for a category of objects or a category of users. As an example and not by way of limitation, a user may specify that no images sent by the user through social-networking system 160 may be stored by social-networking system 160. As another example and not by way of limitation, a first user may specify that no content that is sent from the first user to a particular second user can be stored by social-networking system 160. As yet another example and not by way of limitation, a user may specify that all content sent through a particular application of his or her computing device may be saved by social-networking system 160.

In particular embodiments, social-networking system 160 may determine that one or more privacy settings associated with a first user may need to be changed in response to a trigger action. The trigger action may be any suitable action on the online social network. As an example and not by way of limitation, a trigger action may be a change in the relationship between a first and second user of the online social network (e.g., “un-friending” a user, changing the relationship status between the users). In particular embodiments, upon determining that a trigger action has occurred, social-networking system 160 may prompt the first user to provide new privacy settings regarding the visibility of objects associated with the first user. The prompt may redirect the first user to a workflow process for editing privacy and content settings with respect to one or more entities associated with the trigger action. The privacy settings associated with the first user may only be changed in response to an explicit input from the first user, and may not be changed without the approval of the first user. As an example and not by way of limitation, the workflow process may include providing the first user with the current privacy settings with respect to the second user or to a group of users (e.g., un-tagging the first user or second user from particular objects, changing the visibility of particular objects with respect to the second user or group of users), and receiving an indication from the first user to change the privacy settings based on any of the methods described herein, or to keep the existing privacy settings.

In particular embodiments, users may specify privacy settings for particular types of information received by social-networking system 160 and associated with the user. A user may specify that social-networking system 160 may access particular information provided by the user or a computing device associated with the user, in order for social-networking system 160 to provide a particular function or service to the user, without social-networking system 160 having access to that information for any other purposes. As an example and not by way of limitation, a user may utilize a location services feature of social-networking system 160 to provide recommendations for restaurants or other places in proximity to the user. The user may provide privacy settings to specify that social-networking system 160 may use location information provided from a mobile device of the user to provide the location services, but that social-networking system 160 may not save the location information of the user or provide it to any third-party entities.

In particular embodiments, social-networking system 160 may receive information about the user in a first form, which must be processed to a second form before it can be used by social-networking system 160 or any other party. The user may specify privacy settings that control who has access to the first form of information or the second form of information. As an example and not by way of limitation, social-networking system 160 may receive biometric information from a user. The biometric information may comprise data about a user characteristic that is unique to the user, as well as additional information to be used by social-networking system 160. A user's privacy settings may individually specify which parties have access to the unique characteristics of the biometric information, as well as the additional information provided. As a particular example, a user may provide a voice recording to social-networking system 160, wherein the words spoken by the user comprises a status update. Social-networking system 160 may prompt the user to provide privacy settings for the underlying biometric information of the voice recording (such as the user's vocal characteristics), as well as the additional information (the status update).

As another example and not by way of limitation, a user may use an application of social-networking system 160 to perform voice searches (e.g. performing a search by speaking search terms such as “what time does the football game start?”). The user may grant permission for the application to send the voice recording of the user to social-networking system 160 in order to perform the search. In one example, the user may permit social-networking system 160 to save the voice recording in order to improve future search functions and/or voice recognition capabilities. As another example, the user may permit social-networking system 160 to save the search terms from the voice recording, but deny permission for social-networking system 160 to save the voice recording itself or to use the voice recording for any other purpose. As another example, the user may prohibit social-networking system 160 from saving the voice recording or the search terms.

In particular embodiments, privacy settings may be specified for each of a plurality of applications on a computing device associated with a user. As an example and not by way of limitation, a particular user may be associated with a mobile computing device running a messaging application associated with social-networking system 160, an image-sharing application associated with social-networking system 160, and a search application associated with social-networking system 160. Social-networking system 160 may determine default privacy settings for each application of the mobile computing device. In particular embodiments, when the user initially launches each of the applications associated with social-networking system 160, the application may prompt the user to provide a privacy setting for that application. In particular embodiments, the application prompt may include individual privacy settings for a plurality of user actions available for that application. As an example and not by way of limitation, when a user first launches an image-sharing application on their mobile computing device, the application may ask the user to provide privacy settings for: images posted by the user; images posted by the user where the user is tagged in the image; images posted by other users where the user is tagged in the image; video files where the user is tagged; or posts where the user is tagged.

In particular embodiments, the privacy setting associated with an object may require a second layer of user verification before the object is visible to other users. As an example and not by way of limitation, a user's default privacy settings may indicate that a particular type of user action is visible to a set of users. However, social-networking system 160 may determine that a specific user action is related to a topic or situation that may require heightened privacy. As an example and not by way of limitation, a user's posts comprising the user's status updates may normally be visible to all friends of the user on social-networking system 160. However, the user may then post a status update related to a topic sensitive to the user, such as the end of a relationship. Social-networking system 160 may determine that the particular post is very sensitive, and send a prompt to the user reminding the user of his or her privacy settings, and provide an option for the user to change his or her default privacy settings, or alter his or her privacy settings only with respect to the particular post.

In particular embodiments, social-networking system 160 may send a reminder to a user of his or her privacy setting in response to a user action associated with that privacy setting. As an example and not by way of limitation, a user may specify a set of privacy settings identifying a set of users who are permitted to view images posted by the user on social-networking system 160. If the user subsequently posts a photo to social-networking system 160, the user may receive an indication of the current privacy settings of the user, and an identification of the set of users who will be able to access the photo. In particular embodiments, the indication may include user inputs to permit the user to continue with sharing the photo to the set of users, cancel the sharing of the photo, or to edit the set of users who may view the photo. In particular embodiments, the reminder may be sent every time the user engages in a user action associated with the privacy setting. In particular embodiments, the reminder may be sent periodically based either on time elapsed or a number of user actions. As an example and not by way of limitation, social-networking system 160 may send a reminder to the user every 10th time the user posts a status update. As another example and not by way of limitation, social-networking system 160 may send a reminder once a week, with the user's first user action in a particular week resulting in the reminder being sent.

### Systems and Methods

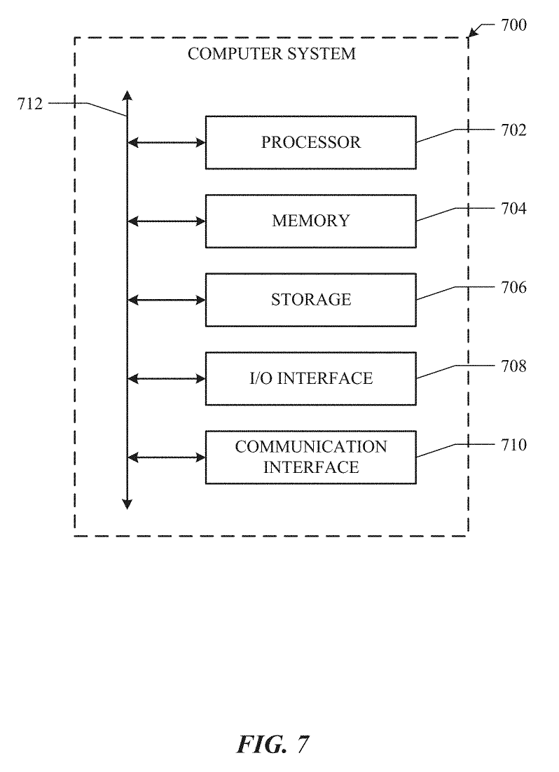

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by one or more computing devices:
receiving, from a client system of a first user of an online social network, a text query comprising one or more n-grams inputted by the first user;
identifying a first set of candidate keyword phrases matching the one or more n-grams of the text query, wherein each candidate keyword phrase in the first set comprises one or more n-grams extracted from content associated with a third-party content object interacted with by the first user;
calculating a rank for each of the identified candidate keyword phrases based at least in part on a social-interaction history of the first user; and
sending, to the client system of the first user for display in response to the first user inputting the one or more n-grams of the text query, one or more suggested queries, wherein at least one of the suggested queries comprises one of the identified candidate keyword phrases associated with a third-party content object having a rank higher than a threshold rank.

2. The method of claim 1, further comprising:
accessing a social graph comprising a plurality of nodes and a plurality of edges connecting the nodes, each of the edges between two of the nodes representing a single degree of separation between them, the nodes comprising:
a first node corresponding to the first user of the online social network;
a plurality of user nodes corresponding to a plurality of second users of the online social network, respectively; and
a plurality of content nodes corresponding to a plurality of third-party content objects, respectively.

3. The method of claim 1, wherein the third-party content object is stored in a third-party system.

4. The method of claim 1, further comprising identifying a second set of candidate keyword phrases matching the one or more n-grams of the text query, wherein each candidate keyword phrase in the second set comprises one or more n-grams extracted from content associated with a native content object interacted with by the first user, the native content object being stored in a data store associated with the online social network.

5. The method of claim 1, wherein the first user interacting with a third-party content object comprises one or more of:
accessing the third-party content object via a link on the online social network;
posting, to the online social network, a link to the third-party content object;
accessing a content object of the online social network associated with the third-party content object;
commenting on a content object of the online social network associated with the third-party content object;
liking a content object of the online social network associated with the third-party content object;
sharing a content object of the online social network associated with the third-party content object; or
accessing a search result from the online social network, wherein the search result references the third-party content object.

6. The method of claim 1, further comprising:
extracting, from content associated with a third-party content object, one or more n-grams via a machine-learning algorithm;
generating one or more candidate keyword phrases based on the extracted n-grams; and
storing the generated candidate keyword phrases in association with the third-party content object.

7. The method of claim 6, wherein storing the generated candidate keyword phrases in association with the third-party content object comprises storing the candidate keyword phrases in one or more data stores associated with the online social network.

8. The method of claim 6, wherein storing the generated candidate keyword phrases in association with the third-party content object comprises storing the candidate keyword phrases on a local cache of the client system of the first user.

9. The method of claim 6, wherein the candidate keyword phrases are pre-generated by an auto-suggestion system prior to the first user interacting with one or more third-party content obj ects.

10. The method of claim 1, wherein the content associated with a third-party content object comprises on or more of:
text of the third-party content object;
text of another content object determined to be similar to or of the same category as the third-party content object;
a descriptive tag associated with the third-party content object;
text of a content object of the online social network associated with the third-party content object; or
a search query associated with the third-party content object.

11. The method of claim 1, wherein the first user interacted with each third-party content object within a specified timeframe.

12. The method of claim 1, wherein the social-interaction history of the first user comprises one or more online interactions of the first user, wherein the online interactions comprise one or more of:
accessing a third-party content object via a link on the online social network;
posting, to the online social network, a link to a third-party content object;
accessing a content object of the online social network associated with a third party content object;
commenting on a content object of the online social network associated with a third-party content object;
liking a content object of the online social network associated with a third-party content object;
sharing a content object of the online social network associated with a third-party content object; or
accessing a search result from the online social network wherein the search result references a third-party content object.

13. The method of claim 12, wherein the rank for each identified candidate keyword phrase is further based on a time decay factor associated with an online interaction of the first user associated with the content object from which the n-grams corresponding to the candidate keyword phrase were extracted.

14. The method of claim 1, wherein the social-interaction history of the first user comprises clickstream data of the first user, the clickstream data comprising information about one or more online interactions of the first user with one or more third-party content objects.

15. The method of claim 1, wherein calculating the rank for each identified candidate keyword phrase is further based on a social-interaction history of a friend of the first user on the online social network or a user of the online social network determined to be similar to the first user.

16. The method of claim 1, wherein calculating the rank for each identified candidate keyword phrase is further based on analysis of the candidate keyword phrase according to a language model.

17. The method of claim 1, wherein calculating the rank for each identified candidate keyword phrase comprises:
determining that a first candidate keyword phrase comprises an n-gram appearing in content associated with more than one third-party content objects interacted with by the first user;
calculating a number of third-party content objects interacted with by the first user that comprise the n-gram; and
up-ranking the first candidate keyword phrase based on the calculated number of third-party content objects.

18. The method of claim 1, wherein one or more of the suggested queries sent to the client system of the first user comprise one or more keyword phrases generated based on one or more of:
a name of a user or an entity on the online social network;
a language database;
a list of trending-topic keyword phrases; or
a search history associated with the first user.

19. One or more computer-readable non-transitory storage media embodying software that is operable when executed to:
receive, from a client system of a first user of an online social network, a text query comprising one or more n-grams inputted by the first user;
identify a first set of candidate keyword phrases matching the one or more n-grams of the text query, wherein each candidate keyword phrase in the first set comprises one or more n-grams extracted from content associated with a third-party content object interacted with by the first user;
calculate a rank for each of the identified candidate keyword phrases based at least in part on a social-interaction history of the first user; and
send, to the client system of the first user for display in response to the first user inputting the one or more n-grams of the text query, one or more suggested queries, wherein at least one of the suggested queries comprises one of the identified candidate keyword phrases associated with a third-party content object having a rank higher than a threshold rank.

20. A system comprising: one or more processors; and a non-transitory memory coupled to the processors comprising instructions executable by the processors, the processors operable when executing the instructions to:
receive, from a client system of a first user of an online social network, a text query comprising one or more n-grams inputted by the first user;
identify a first set of candidate keyword phrases matching the one or more n-grams of the text query, wherein each candidate keyword phrase in the first set comprises one or more n-grams extracted from content associated with a third-party content object interacted with by the first user;
calculate a rank for each of the identified candidate keyword phrases based at least in part on a social-interaction history of the first user; and
send, to the client system of the first user for display in response to the first user inputting the one or more n-grams of the text query, one or more suggested queries, wherein at least one of the suggested queries comprises one of the identified candidate keyword phrases associated with a third-party content object having a rank higher than a threshold rank.
